(19) United States
(12) Patent Application Publication
(10) Pub. No.: US 2012/0099840 A1
(43) Pub. Date: Apr. 26, 2012

(54) TERMINAL DEVICE, SERVER DEVICE AND INFORMATION PROCESSING METHOD THEREFOR

(75) Inventors: Tsuyoshi Namiki, Saitama (JP); Takeshi Koda, Tokyo (JP); Katsutoshi Inagaki, Saitama (JP); Masayoshi Yoshida, Saitama (JP)

(73) Assignee: PIONEER CORPORATION, Kanagawa (JP)

(21) Appl. No.: 13/383,353

(22) PCT Filed: Jul. 13, 2009
(86) PCT No.: PCT/JP2009/062674

§ 371 Date: Jan. 10, 2012

(51) Int. Cl. H04N 9/80

(52) U.S. Cl. 386/248; 386/E05.001

(57) ABSTRACT

The terminal device is configured to be able to reproduce and record contents, and performs reproduction and recording of an optical disc of high recording density, such as a BD. The offer information receiving unit receives the offer information, indicating a condition for performing the managed copy defined by the AACS, from the managed copy server. The offer information transmitting unit transmits the offer information to the server device in order to register the offer information with the server device. By this, the offer information of plural contents can be managed by the server device, and plural users can appropriately share the offer information. Therefore, it becomes possible to know the offer information of a disc, in advance, without actually buying the disc.

### TECHNICAL FIELD

The present invention relates to a terminal device, a server device and an information processing method used for them.

### BACKGROUND TECHNIQUE

Conventionally, there is known a service in which TOC (Table of Contents) information recorded on a music compact disc in advance is transmitted to a server and the contents associated information such as song titles registered in correspondence with the TOC information in the server is provided to a user. For example, Patent Reference 1 proposes a technique of realizing the service providing processing for a DVD (Digital Versatile Disc) and a BD (Blu-ray Disc), similar to the processing of obtaining the contents associated information by using the TOC information in a CD.

### PRIOR ART REFERENCE

### Patent Reference

Patent Reference 1: Japanese Patent Application Laid-open under No. 2008-140440

### SUMMARY OF INVENTION

### Problem to be Solved by the Invention

By the way, there is known a Managed Copy prescribed by an ARCS (Advanced Access Content System) used in a BD. The Managed Copy is a copyright protection technique that permits copying digital contents by executing authentication via a network. Concretely, according to this technique, if a user who bought a disc such as a BD pays the price determined by the contents provider through a predetermined procedure, the user is permitted to copy the whole or a part of the contents in the disc to a local hard-disk and/or a removable medium. Specifically, the user is permitted to perform the copy by communicating with the server of the contents provider of the disc to obtain information (hereinafter referred to as “offer information”) including copyable titles and/or prices necessary for copying and then executing the charging procedure according to the offer information.

Therefore, the user cannot obtain the offer information without actually buying the disc and accessing the server of the contents provider of the disc (hereinafter referred to as “managed copy server”). For example, before buying the disc, the user cannot know information as to what kind of copy is permitted for the disc and/or how much the price for copying. The above-mentioned Patent Reference 1 does not disclose such a problem and a means for solving it.

The above is one of the problem to be solved by the present invention. It is an object of the present invention to provide a terminal device, a server device and an information processing method used therefor, capable of obtaining offer information appropriately and conveniently by sharing the offer information.

### Means for Solving the Problem

The invention of claim 1 is a terminal device for reproducing contents from and recording contents on a medium, including: an offer information receiving unit which receives offer information, indicating a condition for performing a copy of the contents, from a copy management server; and an offer information transmitting unit which transmits the offer information to a server device in order to register the offer information received by the offer information receiving unit with the server device.

The invention of claim 5 is a terminal device for reproducing contents from and recording contents on a medium, including: a first offer information receiving unit which receives offer information, indicating a condition for performing a copy of the contents, from a copy management server; an offer information storing unit which stores the offer information received by the first offer information receiving unit; and an offer information transmitting unit which transmits the offer information stored in the offer information storing unit.

The invention of claim 8 is a server device including: an offer information receiving unit which receives offer information, indicating a condition for performing a copy of the contents, from the terminal device according to any one of claims 1 to 4; an offer information storing unit which stores the offer information received by the offer information receiving unit; and an offer information transmitting unit which transmits the offer information stored in the offer information storing unit to the terminal device in response to a request from the terminal device.

The invention of claim 11 is an information processing method executed by a terminal device for reproducing contents from and recording contents on a medium, including: an offer information receiving step which receives offer information, indicating a condition for performing a copy of the contents, from a copy management server; and an offer information transmitting step which transmits the offer information to a server device in order to register the offer information received by the offer information receiving step with the server device.

The invention of claim 12 is an information processing method executed by a terminal device for reproducing contents from and recording contents on a medium, including: a first offer information receiving step which receives offer information, indicating a condition for performing a copy of the contents, from a copy management server; an offer information storing step which stores the offer information received by the first offer information receiving step; and an offer information transmitting step which transmits the offer information stored by the offer information storing step.

The invention of claim 13 is an information processing method executed by a terminal device for reproducing contents from and recording contents on a medium, including: a first offer information receiving step which receives offer information, indicating a condition for performing a copy of the contents, from a copy management server; a processing step which applies a predetermined processing onto the offer information received by the first offer information receiving step; an offer information storing step which stores the offer information to which the predetermined processing is applied; and an offer information transmitting step which transmits the offer information stored by the offer information storing step.

The invention of claim 14 is an information processing method including: an offer information receiving step which receives offer information, indicating a condition for performing a copy of the contents, from the terminal device according to any one of claims 1 to 4; an offer information storing step which stores the offer information received by the offer information receiving step; and an offer information transmitting step which transmits the offer information stored by the offer information storing step to the terminal device in response to a request from the terminal device.

### BRIEF DESCRIPTION OF THE DRAWINGS

FIG. 1 is a schematic diagram showing a configuration of an information processing system according to an embodiment.

FIGS. 2A to 2C are diagrams showing examples of offer information.

FIGS. 3A and 3B are diagrams showing examples of an offer information management list.

FIGS. 4A and 4B are display examples on an information terminal.

FIG. 5 is a flowchart showing a process for registering registration-purpose offer information with an offer information management server.

FIG. 6 is a flowchart showing a process for referring to presentation-purpose offer information.

FIG. 7 is a flowchart showing a process for adding the registration-purpose offer information to the offer information management list.

FIG. 8 is a flowchart showing a process for providing an information terminal with the presentation-purpose offer information.

FIG. 9 is a schematic diagram showing a configuration of an information processing system according to a modified example.

### PREFERRED FORM TO EXERCISE THE INVENTION

According to one aspect of the present invention, there is provided a terminal device for reproducing contents from and recording contents on a medium, including: an offer information receiving unit which receives offer information, indicating a condition for performing a copy of the contents, from a copy management server; and an offer information transmitting unit which transmits the offer information to a server device in order to register the offer information received by the offer information receiving unit with the server device.

The above terminal device is configured to be able to reproduce and record contents, and performs reproduction and recording of an optical disc of high recording density, such as a BD. The offer information receiving unit receives the offer information, indicating a condition for performing a copy, from the copy management server. The offer information transmitting unit transmits the offer information to the server device in order to register the offer information with the server device. By this, the offer information of plural contents can be managed by the server device, and plural users can appropriately share the offer information. Therefore, it becomes possible to know the offer information of a disc, in advance, without actually buying the disc.

One mode of the above terminal device further includes an offer information requesting unit which requests, to the copy management server, the offer information for the contents recorded on the medium when the medium is inserted. By this, the offer information requested by the user can be conveniently obtained.

Preferably, the above terminal device further includes a transmitting unit which transmits information relating to a number of times of reproducing the contents to the server device. By this, the server device can manage the number of times of reproducing the contents.

Another mode of the above terminal device, further includes: a unit which transmits, to the server device, information indicating that a copy of the contents is performed when the copy of the contents is performed in the terminal device; a unit which receives information indicating a title of popular contents, which is generated in the server device based on information received from plural terminal devices and indicating that the copy is performed; and a unit which displays the information indicating the title of the popular contents. By this, since the popular copy list can be provided to the user in advance, it becomes possible to enhance the user's buying intention at the time of buying a disc.

According to another aspect of the present invention, there is provided a terminal device for reproducing contents from and recording contents on a medium, including: a first offer information receiving unit which receives offer information, indicating a condition for performing a copy of the contents, from a copy management server; an offer information storing unit which stores the offer information received by the first offer information receiving unit; and an offer information transmitting unit which transmits the offer information stored in the offer information storing unit.

The above terminal device stores the received offer information, and transmits the stored offer information. Concretely, the terminal device transmits the stored offer information in response to the request by other terminal device. By this, the server device does not have to manage the offer information itself, and it is sufficient for the server device to information of the terminal device which manages the offer information, thus reducing the burden on the server device.

One mode of the terminal device further includes a second offer information receiving unit which receives the offer information stored in the offer information storing unit of a different terminal device from the offer information transmitting unit of the different terminal device. By this, the offer information requested by the user can be conveniently obtained.

Further, the offer information includes a title for which the copy of the contents is permitted and a price required to copy the title.

According to another aspect of the present invention, there is provided a server device including: an offer information receiving unit which receives offer information, indicating a condition for performing a copy of the contents, from the terminal device according to any one of claims 1 to 4; an offer information storing unit which stores the offer information received by the offer information receiving unit; and an offer information transmitting unit which transmits the offer information stored in the offer information storing unit to the terminal device in response to a request from the terminal device.

The above server device is configured as a common server for the above terminal device. Concretely, the server device receives, from the terminal device, the offer information that the terminal device receives from the copy management server. Then, the server device stores the received offer information, and transmits the stored offer information to the terminal device in response to the request by the terminal device. By this, the offer information of plural contents can be appropriately shared by plural users, and the user can know the offer information of a disc in advance without actually buying the disc.

One mode of the above server device further includes: a unit which receives, from the terminal device, information indicating that a copy is performed when the copy is performed in the terminal device; a unit which generates information indicating a title of popular contents, based on the information received from plural terminal devices and indicating that the copy is performed; and a unit which transmits the information indicating the title of the popular contents to the terminal device. By this, since the popular copy list can be provided to the user in advance, it becomes possible to enhance the user's buying intention at the time of buying a disc.

Another mode of the above server device further includes a unit which updates an already-stored offer information by a received offer information or adds the received offer information, when the offer information receiving unit receives the received offer information for the same contents as the already-stored offer information which has already been stored in the offer information storing unit. By this, newest offer information can be stored.

According to still another aspect of the present invention, there is provided an information processing method, executed by a device for reproducing contents from and recording contents on a medium, which receives offer information from a copy management server and transmits the offer information to the server device. Further, there is provided an information processing method, executed by a device for reproducing contents from and recording contents on a medium, which stores offer information received from a copy management server and transmits the stored offer information. Further, there is provided an information processing method which stores the offer information received from the above terminal device, and transmits the stored offer information in response to the request by the terminal device. Further, there is provided an information processing method, executed by a device for reproducing contents from and recording contents on a medium, which applies a predetermined processing onto the offer information received from the copy management server, stores the offer information to which the predetermined processing is applied, and transmits the stored offer information.

### EMBODIMENT

A preferred embodiment of the present invention will be described below with reference to the attached drawings.

### [Information Processing System]

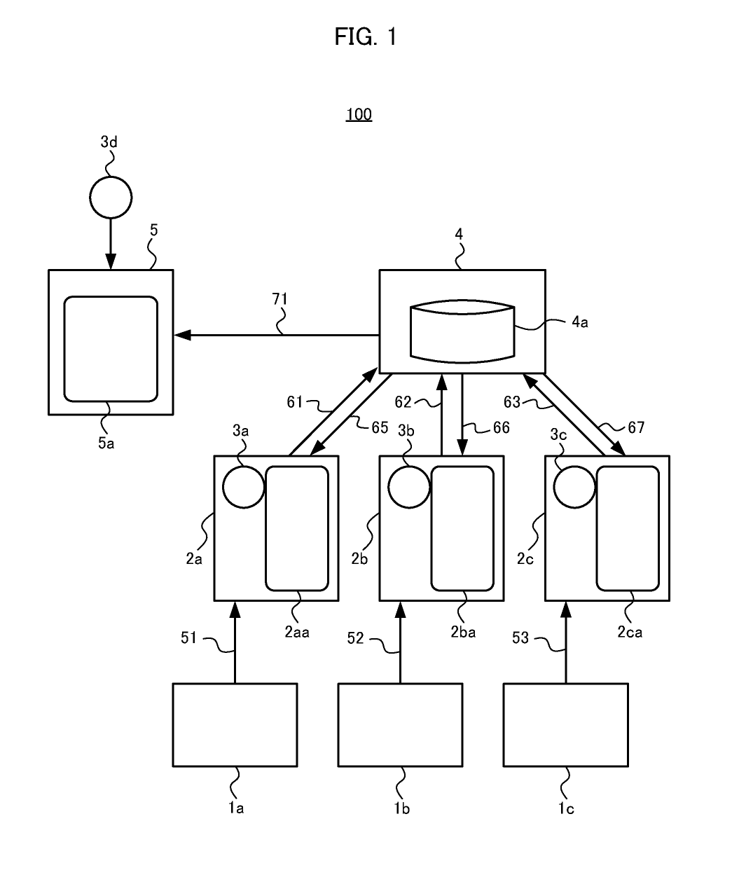

FIG. 1 is a schematic diagram illustrating a configuration of an information processing system 100 according to an embodiment of the present invention. The information processing system 100 includes information terminals 2a to 2c, an offer information management server 4 and an information terminal 5. The information processing system 100 mainly executes a process for registering offer information obtained in the information terminals 2a to 2c with the offer information management server 4 and a process for presenting the offer information managed by the offer information management server 4 to the information terminals 2a to 2c and the information terminal 5.

The information terminals 2a to 2c include a CPU (Central Processing Unit), a ROM (Read Only Memory) and a RAM (Random Access Memory) which are not shown. The information terminals 2a to 2c have a function of executing the managed copy, and are configured to be able to connect to a network. The information terminals 2a to 2c are configured to be able to reproduce and record a disc such as a BD. FIG. 1 illustrates an example in which discs 3a to 3c are inserted to the information terminals 2a to 2c, respectively. The information terminals 2a to 2c perform the communication with the managed copy servers 1a to 1c to receive the offer information for the discs 3a to 3c, respectively, as shown by the arrows 51 to 53. The managed copy servers 1a to 1c correspond to a copy management server. Concretely, the managed copy servers 1a to 1c are authentication servers related to the managed copy, which are owned by a contents provider of the discs 3a to 3c and/or a disc producing company. The offer information is information indicating a condition for performing the managed copy of the contents. Concretely, the offer information is information of a list of the titles for which copying the contents is permitted and/or the prices necessary to copy the titles.

Specifically, the information terminals 2a to 2c receive the offer information by issuing a request offer to the managed copy servers 1a to 1c when the discs 3a to 3c are inserted. Namely, the information terminals 2a to 2c execute the process for obtaining the offer information, regardless that the managed copy of the contents in the discs 3a to 3c is performed or not. In FIG. 1, the offer information received by the information terminals 2a to 2c are shown by the reference numerals 2aa to 2ca. The information terminals 2a to 2c display the contents of the offer information thus received on a display unit (not shown).

In order to register the offer information received from the managed copy servers 1a to 1c with the offer information management server 4, the information terminals 2a to 2c transmit the offer information to the offer information management server 4, respectively, as shown by the arrows 61 to 63. It is not limited that the information terminals 2a to 2c transmit the same information as the offer information received from the managed copy servers 1a to 1c to the offer information management server 4 as it is, and the information terminals 2a to 2c may transmit information, to which predetermined processing is applied based on the offer information received from the managed copy server 1, to the offer information management server 4. Also, the information terminals 2a to 2c may transmit the information of the number of times of reproducing the discs 3a to 3c to the offer information management server 4, in addition to the above-described offer information.

By issuing the request to the offer information management server 4, the information terminals 2a to 2c receive desired offer information from the offer information management server 4 as shown by the arrows 65 to 67. For example, when the user operates the information terminals 2a to 2c to specify the disc whose offer information the user wants to refer to, the information terminals 2a to 2c receive the offer information of the specified disc from the offer information management server 4. The information terminals 2a to 2c display the contents of the offer information thus received on the display unit (not shown). Thus, the information terminals 2a to 2c correspond to the terminal device in the present invention. Concretely, the information terminals 2a to 2c function as an offer information receiving unit, an offer information transmitting unit and an offer information requesting unit.

Hereinafter, the information terminals 2a to 2c are simply expressed as “the information terminal 2” if they are not distinguished from each other. Also, the managed copy servers 1a to 1c are simply expressed as “the managed copy server 1” if they are not distinguished from each other. It is not limited that the information processing system 100 includes three information terminals 2a to 2c as shown in FIG. 1. The information processing system 100 may include four or more information terminals 2.

The offer information management server 4 includes an offer information database 4a as well as a CPU, a ROM and a RAM which are not shown, and is configured as a common server to the information terminals 2a to 2c and 5. The offer information management server 4 receives the offer information for the discs 3a to 3c from the information terminals 2a to 2c, respectively, as shown by the arrows 61 to 63. The offer information management server 4 stores the offer information thus received into the offer information database 4a. In the offer information database 4a, the offer information is stored in a form of the list for each disc, for example. The list managed in the offer information database 4a will be hereinafter referred to as “an offer information management list”. More specifically, when the offer information management server 4 receives the offer information of the contents identical to the contents whose offer information has already been stored in the offer information database 4a, the offer information management server 4 updates the offer information by replacing the already-stored offer information by the received offer information, or adds the received offer information, as necessary.

In response to the request from the information terminals 2a to 2c and the information terminal 5, the offer information management server 4 transmits the offer information stored in the offer information database 4a, as shown by the arrows 65 to 67 and 71. Concretely, by searching the offer information database 4a, the offer information management server 4 obtains the offer information corresponding to the request from the information terminals 2a to 2c and the information terminal 5, and transmits them to the information terminals 2a to 2c and the information terminals. It is not limited that the offer information management server 4 transmits the information identical to the offer information received from the information terminal 2 to the information terminal 2 as it is. The offer information management server 4 may transmit the offer information, after applying the predetermined processing based on the offer information received from the information terminal 2, to the information terminal 2.

When the managed copy is performed in the information terminals 2a to 2c, the offer information management server 4 receives information indicating that the managed copy is performed from the information terminals 2a to 2c. The information indicating that the managed copy is performed includes information of the disc name and/or the title subjected to the managed copy. By receiving such information, the offer information management server 4 manages the copy history by plural users for each title. Then, the offer information management server 4 generates information indicating the titles of the popular contents (hereinafter referred to as “a popular copy list”) from the information indicating that the managed copy is performed, which is received from the information terminals 2a to 2c. Concretely, the offer information management server 4 creates a database of the history of the titles that plural users copied, and/or the number of times that the offer information is registered for a certain title, thereby to generate the popular copy list. Then, the offer information management server 4 transmits the generated popular copy list to the information terminals 2a to 2c and the information terminal 5. The popular copy list thus transmitted is displayed on the display unit (not shown) of the information terminals 2a to 2c and the information terminal 5. Thus, the offer information management server 4 corresponds to a server device in the present invention. Concretely, the offer information management server 4 functions as an offer information receiving unit, an offer information storing unit and an offer information transmitting unit.

The information terminal 5 includes a CPU, a ROM and a RAM, which are not shown, and is configured to be able to access the offer information management server 4. The information terminal 5 is provided in a disc shop and/or an online shop dealing in discs such as BD. The information terminal 5 identifies the disc 3d based on the information obtained by reading a barcode and/or an ISAN (Internet Standard Audiovisual Number) code (hereinafter referred to as “disc identification information”). The reason for identifying the disc 3d in this way is that it is not possible to open a package of a new disc and reproduce it.

Then, by issuing a request for the offer information of the identified disc 3d to the offer information management server 4, the information terminal 5 receives the offer information of the disc 3d as shown by the arrow 71. In FIG. 1, the received offer information is shown by the reference numeral 5a. The information terminal 5 displays the contents of the received offer information on the display unit (not shown). Thus, the information terminal 5 corresponds to a terminal device in the present invention. In the following description, if the information terminal 5 and the information terminal 2 are used without distinction, they are expressed in a unified manner as “the information terminal 2”.

In this way, in the information processing system 100 according to this embodiment, the information terminal 2 owned by the user who bought the disc obtains the offer information from the managed copy server 1, and registers the offer information with the offer information management server 4. Then, the offer information management server 4 manages the offer information. Thus, the offer information of plural discs can be appropriately shared by plural users. Therefore, it is possible to know the copy contents permitted for the disc and/or the price for the copy in advance, without actually buying the disc. In addition, since the process executed by the information processing system 100 does not depend on a certain contents provider and/or an authentication server of the managed copy, the information can be uniformly obtained from the users regardless of the titles. Further, according to this embodiment, since the popular copy list can be provide to the user in advance, it is possible to enhance the buying intention at the time of buying a disc.

Further, according to the information terminal 5 in this embodiment, it is possible to immediately notify the user of the offer information of the disc then and there in a disc shop dealing in discs such as BD.

Here, the offer information in this embodiment is compared with CDDB (Compact Disc DataBase). For a CD, by using a database called CDDB, there exists such a service that a user can obtain a title list of songs in a CD by sending TOC information of the CD to the server. The characteristic features of the offer information in comparison with the CDDB are that (1) information amount relating to the contents is large, and that (2) accurate information can be obtained because the offer information is provided by the contents holder and an input error by a user does not happen.

### [Concrete Example of Offer Information]

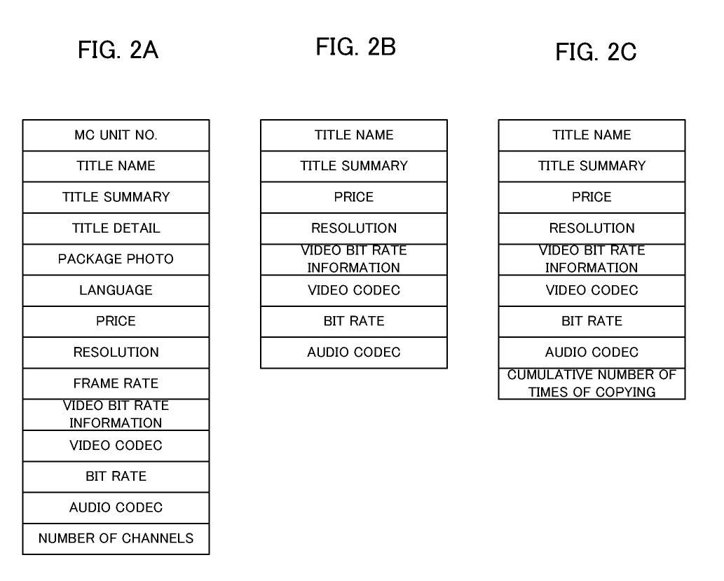

Next, the concrete example of the offer information will be described with reference to FIGS. 2 to 4.

Here, the description will be given of the case where the information terminal 2 transmits the offer information, after applying a predetermined processing to it based on the offer information received from the managed copy server 1, to the offer information management server 4, and the offer management server 4 transmits the offer information, after applying a predetermined processing to it based on the offer information received from the information terminal 2, to the information terminal 2. Namely, the description will be given of the case where the offer information that the information terminal 2 receives from the managed copy server 1, the offer information that the information terminal 2 transmits to the offer information management server 4, and the offer information that the offer information management server 4 transmits to the information terminal 2 are all different from each other.

In the following description, the offer information that the information terminal 2 receives from the managed copy server 1 by issuing the request offer will be called “original offer information”. The offer information that the information terminal 2 transmits to the offer information server 4 so as to be registered with the offer information management server will be called “registration-purpose offer information”. The offer information that the offer information management server 4 transmits to the information terminal 2 in response to the request by the information terminal 2 will be called “presentation-purpose offer information”.

FIGS. 2A to 2C show concrete examples of the offer information. FIG. 2A shows an example of the original offer information. The original offer information is information stored in the managed copy server 1. As shown, the original offer information includes “managed copy (MC) unit number”, “title name”, “title summary”, “title detail”, “package photo”, “language”, “price”, “resolution”, “frame rate”, “video bit rate information”, “video codec”, “bit rate”, “audio codec” and “number of channels”. In the original offer information, the “title name” corresponds to the name of the copyable title, and the “price” corresponds to a price required to copy the copyable title.

FIG. 2B shows an example of the registration-purpose offer information. The registration-purpose offer information is generated by the information terminal 2. As shown, the registration-purpose offer information includes “title name”, “title summary”, “price”, “resolution”, “video bit rate information”, “video codec”, “bit rate” and “audio codec”. Thus, it is understood that the registration-purpose offer information has smaller information amount than the original offer information shown in FIG. 2A.

The information terminal 2 generates the registration-purpose offer information by eliminating predetermined information from the original offer information received from the managed copy server 1. Namely, the information terminal 2 transmits the registration-purpose offer information having smaller information amount than the original offer information to the offer information management server 4. Concretely, the information terminal 2 generates the registration-purpose offer information including the information included in the original offer information indicating what kind of copy is permitted for the disc and how much the price for copying is.

FIG. 2C shows an example of the presentation-purpose offer information. The presentation-purpose offer information is generated by the offer information management server 4. As shown, the presentation-purpose offer information includes “title name”, “title summary”, “price”, “resolution”, “video bit rate information”, “video codec”, “bit rate”, “audio codec” and “cumulative number of times of copying”. Thus, it is understood that the presentation-purpose offer information is obtained by adding the “cumulative number of times of copying” to the registration-purpose offer information.

The “cumulative number of times of copying” is information indicating a cumulative number of time of copying the title of the contents, which is set for each title. Namely, the cumulative number of times of copying corresponds to the history of the title copied by plural users. The title is popular as the cumulative number of times of copying is large. The offer information management server 4 generates the information of the cumulative number of times of copying by incrementing the number of times of copying, every time when it receives the information, indicating that the managed copy is performed, from plural information terminals 2.

In the presentation-purpose offer information, the “price” corresponds to the price required to copy the title, in consideration of the number of times of copying and the timing of the copying in the same information terminal 2. Namely, the price includes the price of 1st copy, second copy, . . . , n-th copy, as well as the price considering the campaign period in which the price for copying is discounted. The offer information management server 4 generates the information of the price based on the registration-purpose offer information obtained from the plural information terminals 2. For example, when the price for copying is changed due to the campaign period, the offer information management server 4 updates the price by replacing the price before the change with the price after the change to generate the information of the price in the presentation-purpose offer information. In this case, if the price returns to the price before the change when the campaign period ends, the price before the change may be stored, without being discarded.

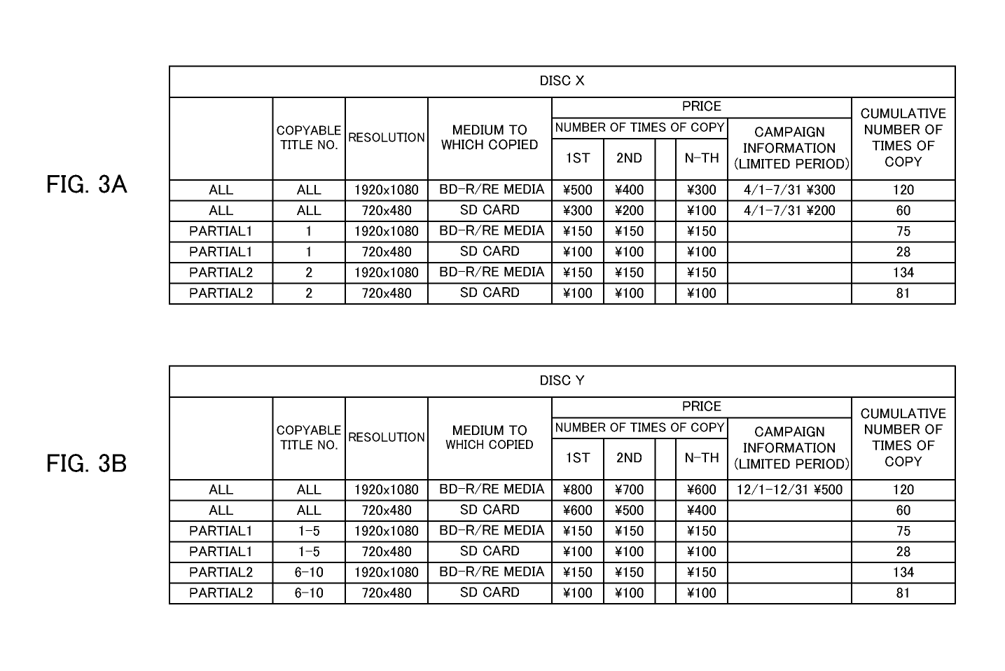

FIGS. 3A and 3B show concrete examples of the offer information management list that the offer information management server 4 manages. FIG. 3A shows an example of the offer information management list of a disc X, and FIG. 3B shows an example of the offer information management list of a disc Y. It is assumed that a drama having two episodes No. 1 and No. 2 are recorded on the disc X, and ten music titles No. 1 to No. 10 are recorded on the disc Y. The offer information management list is generated by the offer information management server 4 based on the registration-purpose offer information received from the information terminal 2.

As shown in FIGS. 3A and 3B, in the offer information management list, information of “copyable title No.”, “resolution”, “medium to which copied”, “price” and “cumulative number of times of copying” are associated for “all”, “partial 1” and “partial 2”, and managed. Concretely, the “resolution” indicates “1920×1080” or “720×480”, and the “medium to which copied” indicates “BD-R/RE medium” or “SD card”. The “price” indicates the price required for the copying in the case where the number of times of the copying is one, two and n (≧3), and includes campaign information such as a limited time campaign. The campaign information is information including the time period in which the price for the copying is discounted and the price required for the copying in the time period. The campaign information is erased when the limited time period has elapsed.

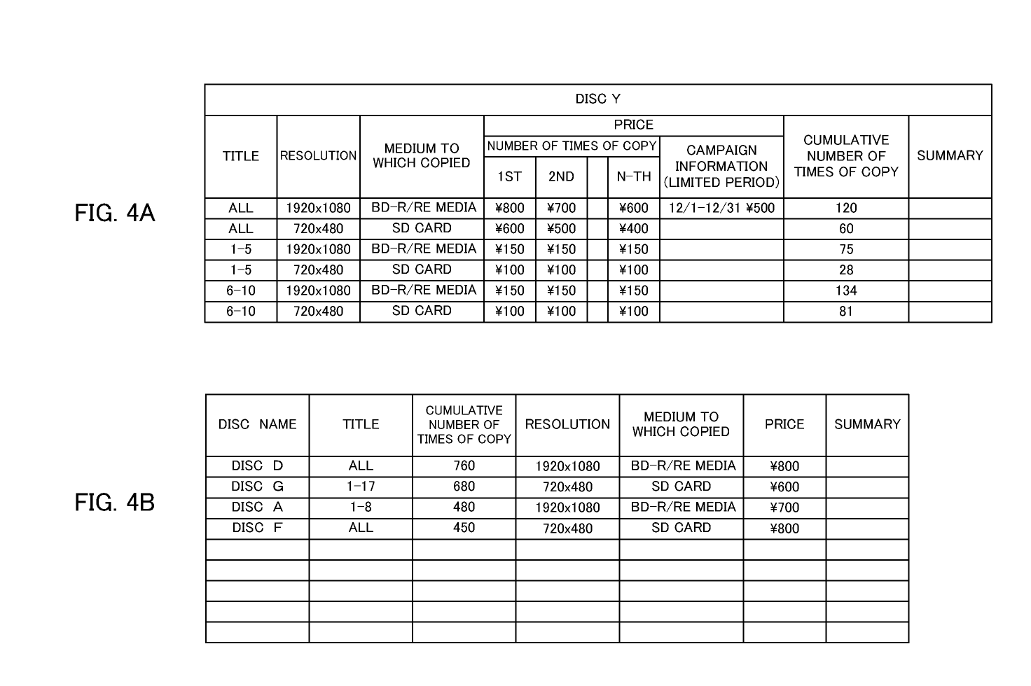

FIGS. 4A and 4B show display examples in the information terminal 2. FIG. 4A shows the display example for the presentation-purpose offer information. Here, the display example for the presentation-purpose offer information of the disc Y shown in FIG. 3B is shown. As shown in FIG. 4A, the contents of the information “copyable title No.”, “resolution”, “medium to which copied”, “price”, “cumulative times of copying” and “summary” associated with “all”, “partial 1” and “partial 2” are displayed. The “resolution”, “medium to which copied” and “price” are the same as those shown in FIGS. 3A and 3B.

The information terminal 2 can sort the order of the titles to be displayed in accordance with the cumulative number of times of copying, when the information terminal 2 displays the presentation-purpose offer information. Namely, the information terminal 2 can display the presentation-purpose offer information for a specific disc by sorting the titles in the order of the popularity from the one having highest popularity, i.e., by sorting the titles in accordance with the copy ranking. By this, the user can perform the managed copy by referring to the copy ranking.

FIG. 4B shows a display example of the popular copy list. As described above, the popular copy list is the information generated by the offer information management server 4 and is transmitted to the information terminal 2. As shown in FIG. 4B, the information is displayed such that the discs are arranged in the order of the popularity, i.e., in the order from the one having largest cumulative number of times of copying. Concretely, the contents of information of “title”, “cumulative number of times of copying”, “resolution”, “medium to which copied”, “price” and “summary” associated with each disc are displayed. The “resolution” and “medium to which copied” are the same as those shown in FIGS. 3A and 3B.

By displaying the popular copy list as shown in FIG. 4B, it is possible to enhance the buying intention of the user at the time of buying a disc.

### [Process in Information Terminal and Offer Information Management Server]

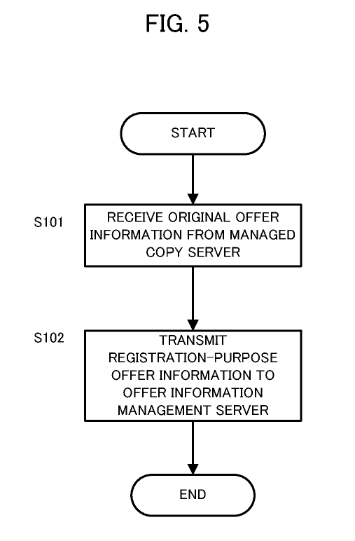

Next, the process in the information terminals 2, 5 and the offer information management server 4 will be concretely described with reference to FIGS. 5 to 8.

FIG. 5 is a flowchart illustrating the process that the information terminal 2 executes to register the registration-purpose offer information with the offer information management server 4. This process is executed after the user inserts the disc into the information terminal 2. For example, this process is executed by the CPU in the information terminal 2 which reads out the program stored in the ROM.

First, in step S101, by issuing the request offer to the managed copy server 1, the information terminal 2 receives the original offer information for the disc inserted into the information terminal 2. Then, the process goes to step S102.

In step S102, in order to register the registration-purpose offer information for the disc inserted into the information terminal 2 with the offer information management server 4, the information terminal 2 transmits the registration-purpose offer information to the offer information management server 4. Concretely, the information terminal 2 generates the registration-purpose offer information by eliminating unnecessary information from the original offer information received in step S101, and transmits the registration-purpose information to the offer information management server 4. The information terminal 2 generates, out of the original offer information, information at least including what kind of copy is permitted for the disc and how much the price of copying, as the registration-purpose offer information. When the process of step S102 ends, the process shown in FIG. 5 ends.

It is noted that the information terminal 2 transmits the registration-purpose offer information to the offer information management server 4, regardless that the disc for which the registration-purpose offer information is to be registered has already been registered with the offer information management server 4 or not.

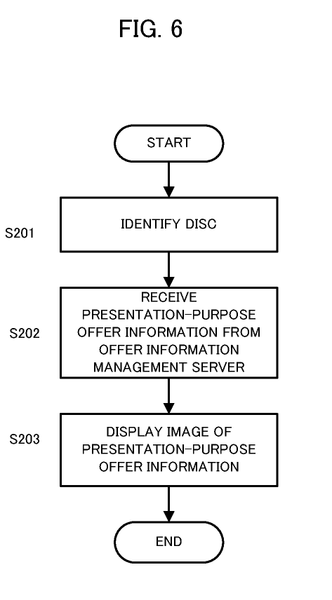

FIG. 6 is a flowchart illustrating the process that the information terminal 5 executed to refer to the presentation-purpose offer information from the offer information management server 4. As described above, the information terminal 5 is provided in a disc shop or an online shop dealing in discs such as a BD. For example, this process is executed by the CPU in the information terminal 5 which reads out the program stored in the ROM.

First, in step S201, the information terminal 5 identifies the disc based on the information obtained by reading out the barcode and/or the ISAN code attached to the package of the disc, i.e., the disc identification information. For example, in the BD shop, the barcode attached to the package of the disc is read out by the barcode reader. Then, the process goes to step S202.

In step S202, by issuing the request for the offer information for the disc identified in step S201 to the offer information management server 4, the information terminal 5 receives the presentation-purpose offer information for the disc. Then, the process goes to step S203. In step S203, the information terminal 5 displays the contents of the presentation-purpose offer information received in step S202. For example, the contents shown in FIG. 4A is displayed. Then, the process ends.

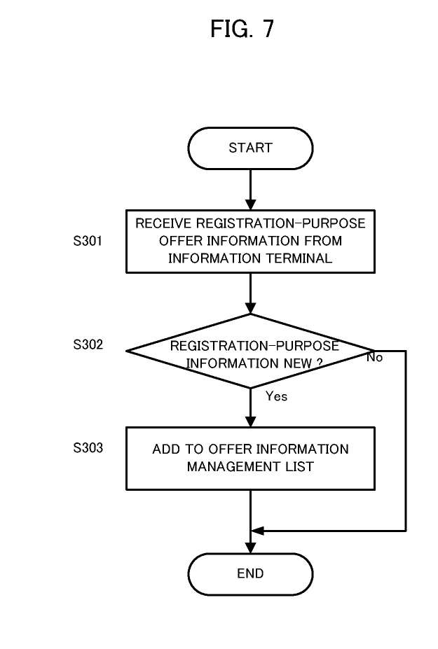

FIG. 7 is a flowchart illustrating the process that the offer information management server 4 executes to add the registration-purpose offer information to the offer information management list. For example, this process is executed by the CPU in the offer information management server 4 which reads out the program stored in the ROM.

First, in step S301, the offer information management server 4 receives the registration-purpose offer information from the information terminal 2. Then, the process goes to step S302.

In step S302, the offer information management server 4 determines whether or not the registration-purpose offer information received in step S301 is new. Concretely, the offer information management server 4 determines whether or not it receives the registration-purpose offer information for the disc, for which the registration-purpose offer information has already been registered.

If the registration-purpose offer information is new (step S302; Yes), the process goes to step S303. In step S303, the offer information management server 4 adds the registration-purpose offer information received in step S301 to the offer information management list, i.e., stores it in the offer information database 4. Then, the process ends.

On the contrary, if the registration-purpose offer information is not new (step S302; No), the process ends. In this case, the offer information management server 4 does not add the registration-purpose offer information received in step S301 to the offer information management list.

It is noted that, even if the registration-purpose offer information is not new, the registration-purpose offer information may be added to the offer information management list. This is because, as described above, the information of the price in the registration-purpose offer information may be changed due to the campaign period or the like, and therefore there is a case where adding the newest registration-purpose offer information to the offer information management list is desired.

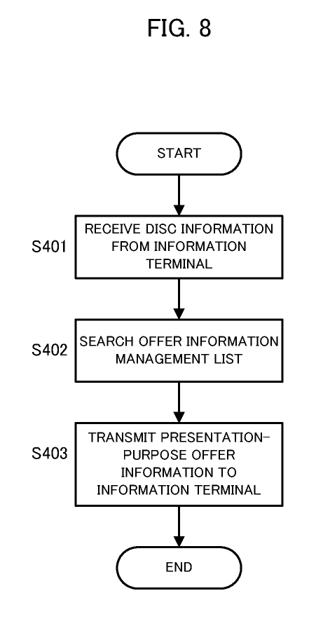

FIG. 8 is a flowchart illustrating the process that the offer information management server 4 executes to provide the presentation-purpose offer information to the information terminal 2. For example, this process is executed by the CPU in the offer information management server 4 which reads out the program stored in the ROM.

First, in step S401, the offer information management server 4 receives the disc information from the information terminal 2. Concretely, the offer information management server 4 receives the information specifying the disc for which the presentation-purpose offer information is to be referred to in the information terminal 2. Namely, the offer information management server 4 receives the request from the information terminal 2. Then, the process goes to step S402.

In step S402, by searching the offer information management list, the offer information management server 4 obtains the presentation-purpose offer information for the disc specified in step S401. Then, the process goes to step S403. In step S403, the offer information management server 4 transmits the presentation-purpose offer information obtained in step S402 to the information terminal 2. Then, the process ends.

According to the process illustrated in FIGS. 5 to 8, plural users can appropriately share the offer information of plural discs, and it becomes possible to know the copy contents permitted for the disc and the price for copying without actually buying the disc.

The description described by referring to FIGS. 2 to 8 shows the example in which the original offer information is different from the registration-purpose offer information, but the same information as the original offer information may be used as the registration-purpose offer information. Namely, the information terminal 2 may transmit the same information as the offer information received from the managed copy server 1 to the offer information management server 4 as it is. Further, while the description is given to the example in which the registration-purpose offer information is different from the presentation-purpose offer information, the same information as the registration-purpose offer information may be used as the presentation-purpose offer information. Namely, the offer information management server 4 may transmit the same information as the offer information received from the information terminal 2 to the information terminal 2 as it is. Further, the same information as the original offer information may be used as the registration-purpose offer information and the presentation-purpose offer information.

### Modified Example

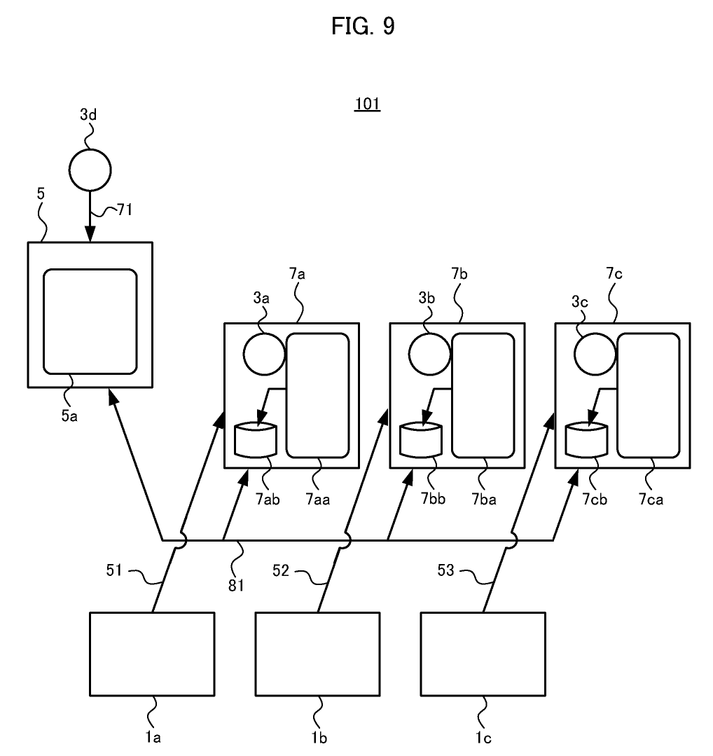

Next, an information processing system according to a modified example will be described with reference to FIG. 9. FIG. 9 is a schematic diagram showing a configuration of an information processing system according to a modified example. The information processing system 101 includes information terminals 7a to 7c and the information terminal 5. The element to which the reference numeral identical to FIG. 1 is applied indicates the same one and the description there of will be omitted.

The information processing system 101 is different from the information processing system 100 in that it includes the information terminals 7a to 7c instead of the information terminals 2a to 2c and it does not include the offer information management server 4. The information processing system 101 shares the offer information by providing a common area for storing the offer information accumulated in the past in the information terminals 7a to 7c and establishing the connection by P2P (Peer to Peer). By this, the same effect as the information processing system 100 can be obtained without providing the offer information management server 4.

The information terminals 7a to 7c will be concretely described. Hereinafter, the information terminals 7a to 7c will be simply expressed as “information terminal 7” if they are not distinguished from each other.

The information terminals 7a to 7c include the offer information databases lab to 7cb, and CPUs, ROMs and RAMS which are not shown. The information terminals 7a to 7c are connected with each other by P2P, and have the function of performing the managed copy. The information terminals 7a to 7c are configured to be able to reproduce and store the disc such as a BD. FIG. 9 shows an example in which the discs 3a to 3c are inserted into the information terminals 7a to 7c, respectively. By communicating with the managed copy servers 1a to 1c, the information terminals 7a to 7c receive the offer information for the discs 3a to 3c, respectively, as shown by the arrows 51 to 53. Specifically, the information terminals 7a to 7c receive the offer information by issuing the request offer to the managed copy servers 1a to 1c, when the discs 3a to 3c are inserted. Namely, the information terminals 7a to 7c execute the process to obtain the offer information, regardless that the managed copy of the contents in the discs 3a to 3c is performed or not. In FIG. 9, the offer information received in the information terminals 7a to 7c are shown by the reference numerals 7aa to 7ca. The information terminals 7a to 7c display the contents of the offer information thus received on the display unit (not shown).

The information terminals 7a to 7c stores the offer information received from the managed copy servers 1a to 1c into the offer information databases 7ab to 7cb, respectively. The offer information databases 7ab to 7cb are the common areas in which the offer information accumulated in the information terminals 7a to 7c in the past are stored. For the offer information received from the managed copy servers 1a to 1c, the information terminals 7a to 7c may store the information including at least what kind of copy is permitted for the disc and how much the price for the copying is. Namely, the information terminals 7a to 7c may store the information obtained by eliminating unnecessary information from the offer information received from the managed copy servers 1a to 1c.

The information terminals 7a to 7c transmit the offer information in response to the request from other information terminals 7a to 7c as shown by the arrow 81, and receive the offer information by issuing the request to other information terminals 7a to 7c. Namely, the information terminals 7a to 7c transmit and receive the offer information stored in the offer information databases 7ab to 7cb. For example, when the user operates the information terminals 7a to 7c to specify the disc for which the user wants to refer to the offer information, the information terminals 7a to 7c issue the request for the offer information of the specified disc. Further, the information terminals 7a to 7c display the contents of the received offer information on the display unit (not shown). Thus, each of the information terminals 7a to 7c corresponds to a terminal device in the present invention. Concretely, each of the information terminals 7a to 7c functions as a first offer information receiving unit, an offer information storing unit, an offer information transmitting unit and a second offer information receiving unit.

By the information processing system 101 as described above, plural users can share the offer information of plural discs, and it becomes possible to know the copying contents permitted for the disc and the price for the copying, without actually buying the disc. Further, since the process executed in the information processing system 101 does not depend on a specific contents provider and an authentication server of the managed copy, it is possible to uniformly obtain information from the users regardless of the titles. Still further, according to the information processing system 101, the server device does not have to manage the offer information itself, and it is sufficient for the server device to manage the information of the terminals managing the offer information, thereby providing an effect of reducing the burden on the server device.

The present invention is not limited to the configuration of the information processing system 101 including three information terminals 7a to 7c as shown in FIG. 9. The information processing system 101 may be configured by four or more information terminals 7. In addition, the information processing system may be configured by a center which manages what kind of disc the offer information is stored in each information terminal 7. Namely, the offer information stored in each information terminal 7 may be managed by using the center.

In addition to the offer information described in the above embodiment and the modified example, it is possible to share sample pictures by which the picture quality and the resolution of the copied contents can be evaluated. For example, such sample pictures are formed by the pictures of a few seconds and are distributed by the managed copy server 1.

### INDUSTRIAL APPLICABILITY

This invention can be used for a device which records and/or reproduces BD or a device which is provided in a disc shop and an online shop dealing in BD.

### DESCRIPTION OF REFERENCE NUMBERS

1a, 1b, 1c Managed copy server
2a, 2b, 2c Information terminal
3a, 3b, 3c Disc
4 Offer information management server
4a Offer information database
5 Information terminal
7a, 7b, 7c Information terminal
100, 101 Information processing system

1. A terminal device for reproducing contents from and recording contents on a medium, comprising:
an offer information receiving unit which receives offer information, indicating a condition for performing a copy of the contents, from a copy management server; and
an offer information transmitting unit which transmits the offer information to a server device in order to register the offer information received by the offer information receiving unit with the server device.

2. The terminal device according to claim 1, further comprising an offer information requesting unit which requests, to the copy management server, the offer information for the contents recorded on the medium when the medium is inserted.

3. The terminal device according to claim 1, further comprising a transmitting unit which transmits information relating to a number of times of reproducing the contents to the server device.

4. The terminal device according to claim 1, further comprising:
a unit which transmits, to the server device, information indicating that a copy of the contents is performed when the copy of the contents is performed in the terminal device;
a unit which receives information indicating a title of popular contents, which is generated in the server device based on information received from plural terminal devices and indicating that the copy is performed; and
a unit which displays the information indicating the title of the popular contents.

5. A terminal device for reproducing contents from and recording contents on a medium, comprising:
a first offer information receiving unit which receives offer information, indicating a condition for performing a copy of the contents, from a copy management server;
an offer information storing unit which stores the offer information received by the first offer information receiving unit; and
an offer information transmitting unit which transmits the offer information stored in the offer information storing unit.

6. The terminal device according to claim 5, further comprising a second offer information receiving unit which receives the offer information stored in the offer information storing unit of a different terminal device from the offer information transmitting unit of the different terminal device.

7. The terminal device according to claim 1, wherein the offer information includes a title for which the copy of the contents is permitted and a price required to copy the title.

8. A server device comprising:
an offer information receiving unit which receives offer information, indicating a condition for performing a copy of the contents, from the terminal device comprising an offer information receiving unit which receives offer information, indicating a condition for performing a copy of the contents, from a copy management server; and an offer information transmitting unit which transmits the offer information to a server device in order to register the offer information received by the offer information receiving unit with the server device;
an offer information storing unit which stores the offer information received by the offer information receiving unit; and
an offer information transmitting unit which transmits the offer information stored in the offer information storing unit to the terminal device in response to a request from the terminal device.

9. The server device according to claim 8, further comprising:
a unit which receives, from the terminal device, information indicating that a copy is performed when the copy is performed in the terminal device;
a unit which generates information indicating a title of popular contents, based on the information received from plural terminal devices and indicating that the copy is performed; and
a unit which transmits the information indicating the title of the popular contents to the terminal device.

10. The server device according to claim 8, further comprising a unit which updates an already-stored offer information by a received offer information or adds the received offer information, when the offer information receiving unit receives the received offer information for the same contents as the already-stored offer information which has already been stored in the offer information storing unit.

11. An information processing method executed by a terminal device for reproducing contents from and recording contents on a medium, comprising:
an offer information receiving step which receives offer information, indicating a condition for performing a copy of the contents, from a copy management server; and
an offer information transmitting step which transmits the offer information to a server device in order to register the offer information received by the offer information receiving step with the server device.

12. An information processing method executed by a terminal device for reproducing contents from and recording contents on a medium, comprising:
a first offer information receiving step which receives offer information, indicating a condition for performing a copy of the contents, from a copy management server;
an offer information storing step which stores the offer information received by the first offer information receiving step; and
an offer information transmitting step which transmits the offer information stored by the offer information storing step.

13. An information processing method executed by a terminal device for reproducing contents from and recording contents on a medium, comprising:
a first offer information receiving step which receives offer information, indicating a condition for performing a copy of the contents, from a copy management server;
a processing step which applies a predetermined processing onto the offer information received by the first offer information receiving step;
an offer information storing step which stores the offer information to which the predetermined processing is applied; and
an offer information transmitting step which transmits the offer information stored by the offer information storing step.

14. An information processing method comprising:
an offer information receiving step which receives offer information, indicating a condition for performing a copy of the contents, from the terminal device comprising an offer information receiving unit which receives offer information, indicating a condition for performing a copy of the contents, from a copy management server; and an offer information transmitting unit which transmits the offer information to a server device in order to register the offer information received by the offer information receiving unit with the server device;
an offer information storing step which stores the offer information received by the offer information receiving step; and
an offer information transmitting step which transmits the offer information stored by the offer information storing step to the terminal device in response to a request from the terminal device.

15. The terminal device according to claim 2, further comprising:
a unit which transmits, to the server device, information indicating that a copy of the contents is performed when the copy of the contents is performed in the terminal device;
a unit which receives information indicating a title of popular contents, which is generated in the server device based on information received from plural terminal devices and indicating that the copy is performed; and
a unit which displays the information indicating the title of the popular contents.

16. The terminal device according to claim 3, further comprising:
a unit which transmits, to the server device, information indicating that a copy of the contents is performed when the copy of the contents is performed in the terminal device;
a unit which receives information indicating a title of popular contents, which is generated in the server device based on information received from plural terminal devices and indicating that the copy is performed; and
a unit which displays the information indicating the title of the popular contents.

17. The terminal device according to claim 2, wherein the offer information includes a title for which the copy of the contents is permitted and a price required to copy the title.

18. The terminal device according to claim 3, wherein the offer information includes a title for which the copy of the contents is permitted and a price required to copy the title.

19. The terminal device according to claim 4, wherein the offer information includes a title for which the copy of the contents is permitted and a price required to copy the title.

20. The terminal device according to claim 5, wherein the offer information includes a title for which the copy of the contents is permitted and a price required to copy the title.
